(19) United States
(12) Patent Application Publication
(10) Pub. No.: US 2014/0357764 A1
(43) Pub. Date: Dec. 4, 2014

(54) THERMOPLASTIC MOLDING COMPOUND HAVING IMPROVED NOTCH IMPACT STRENGTH

(71) Applicants: Sachin Jain, Jalgaon Mh (IN); Sameer Nalawade, Mannheim (DE)

(72) Inventors: Sachin Jain, Jalgaon Mh (IN); Sameer Nalawade, Mannheim (DE)

(73) Assignee: BASF SE, Ludwigshafen (DE)

(21) Appl. No.: 14/346,442

(22) PCT Filed: Sep. 12, 2012
(86) PCT No.: PCT/EP2012/067798

§ 371 Date: Jun. 19, 2014

(30) Foreign Application Priority Data
Sep. 21, 2011 (EP) 11182189.8

(51) Int. Cl. C08L 77/02; C08L 27/06

(52) U.S. Cl. CPC C08L 77/02; C08L 27/06
USPC 523/437; 523/456

(57) ABSTRACT

The invention relates to a thermoplastic molding composition comprising:
A) from 69 to 98% by weight, based on components A and B, of a thermoplastic selected from the group consisting of polyvinyl chloride, polystyrene, polymethyl methacrylate, polyamide, polybutylene terephthalate, and polyoxymethylene;
B) from 2 to 31% by weight, based on components A and B, of a polymer mixture comprising:
   i) from 30 to 70% by weight, based on the total weight of components i to ii, of at least one polyester based on aliphatic and/or aromatic dicarboxylic acids and on an aliphatic dihydroxy compound;
   ii) from 70 to 30% by weight, based on the total weight of components i to ii, of polylactic acid;
   iii) from 0 to 10% by weight, based on the total weight of components i to iv, of a copolymer which contains epoxy groups and which is based on styrene, acrylate, and/or methacrylate;
   iv) from 0 to 15% by weight, based on the total weight of components i to iv, of nucleating agents, lubricants and antiblocking agents, waxes, antistatic agents, and defogging agents, or dyes; and
C) from 0 to 40% by weight, based on components A to C, of other additional materials.

The invention relates to a thermoplastic molding composition comprising:
A) from 69 to 98% by weight, based on components A and B, of a thermoplastic selected from the group consisting of polyvinyl chloride, polystyrene, polymethyl methacrylate, polyamide, polybutylene terephthalate, and polyoxymethylene;
B) from 2 to 31% by weight, based on components A and B, of a polymer mixture comprising:
   i) from 30 to 70% by weight, based on the total weight of components i to ii, of at least one polyester based on aliphatic and/or aromatic dicarboxylic acids and on an aliphatic dihydroxy compound;
   ii) from 70 to 30% by weight, based on the total weight of components i to ii, of polylactic acid;
   iii) from 0 to 10% by weight, based on the total weight of components i to iv, of a copolymer which contains epoxy groups and which is based on styrene, acrylate, and/or methacrylate;
   iv) from 0 to 15% by weight, based on the total weight of components i to iv, of nucleating agents, lubricants and antiblocking agents, waxes, antistatic agents, and defogging agents, or dyes; and
C) from 0 to 40% by weight, based on components A to C, of other additional materials.

Numerous engineering plastics are brittle. They have low impact resistance and in particular low notched impact resistance. This problem arises in particular with the amorphous polymers, for example polyvinyl chloride, polystyrene, or polymethyl methacrylate. However, engineering plastics such as polyamide, polybutylene terephthalate, and polyoxymethylene also still lack ideal impact resistance for some applications.

Previous attempts to solve the brittleness problem have used copolymerization with suitable monomers (known as internal plasticizers) or addition of low-molecular-weight substances (external plasticizers). However, both of the approaches taken hitherto have disadvantages. The internal plasticizer principle requires a bespoke production process, an example being the HIPS (High Impact PolyStyrene) production process. External plasticizers, such as phthalates, alkylsulfonic esters of phenol, or trialkyl citrates, are low-molecular-weight compounds which escape (exude) from the plastic over the course of time. This firstly causes subsequent embrittlement of the plastic, and furthermore some plasticizers, such as phthalates, are hazardous because of their hormone-like effect.

Accordingly, it was an object of the present invention to discover, in particular for amorphous thermoplastics, plasticizers which do not exhibit the abovementioned disadvantages.

Surprisingly, it has been found that incorporation of from 2 to 30% by weight of a polymer mixture B can markedly improve the notched impact resistance of a thermoplastic A. The polymer mixtures B therefore have excellent suitability as plasticizers in thermoplastics.

A more detailed description of the invention follows:

The definition of component A can cover any of the familiar thermoplastics. The definition of a thermoplastic preferably covers any semicrystalline polymer selected from the group consisting of: polyamide, polybutylene terephthalate, and polyoxymethylene, and is particularly preferably an amorphous polymer selected from the group consisting of: polyvinyl chloride, polystyrene, and polymethyl methacrylate. The plasticizer effect of the polymer mixture B is particularly pronounced in the case of the amorphous polymers.

Component B is a polymer mixture comprising:
i) from 30 to 70% by weight, based on the total weight of components i to ii, of at least one polyester based on aliphatic and/or aromatic dicarboxylic acids and on an aliphatic dihydroxy compound;
ii) from 70 to 30% by weight, based on the total weight of components i to ii, of polylactic acid;
iii) from 0 to 10% by weight, based on the total weight of components i to iv, of a copolymer which contains epoxy groups and which is based on styrene, acrylate, and/or methacrylate;
iv) from 0 to 15% by weight, based on the total weight of components i to iv, of nucleating agents, lubricants and antiblocking agents, waxes, antistatic agents, and defogging agents, or dyes.

It is preferable that component B is a mixture comprising:
i) from 39.9 to 49.9% by weight, based on the total weight of components i to iv, of at least one polyester based on aliphatic and aromatic dicarboxylic acids and on an aliphatic dihydroxy compound;
ii) from 59.9 to 39.9% by weight, based on the total weight of components i to iv, of polylactic acid;
iii) from 0.1 to 1% by weight, based on the total weight of components i to iv, of a copolymer which contains epoxy groups and which is based on styrene, acrylate, and/or methacrylate;
iv) from 0.1 to 2% by weight, based on the total weight of components i to iv, of nucleating agents, lubricants and antiblocking agents, waxes, antistatic agents, and defogging agents, or dyes.

The definition of component i covers aliphatic or semiaromatic (aliphatic-aromatic) polyesters.

As mentioned, purely aliphatic polyesters are suitable as component i). The definition of aliphatic polyesters covers poyesters made of aliphatic C₂-C₁₂-alkanediols and of aliphatic C₄-C₃₆-alkanedicarboxylic acids, examples being polybutylene succinate (PBS), polybutylene adipate (PBA), polybutylene succinate adipate (PBSA), polybutylene succinate sebacate (PBSSe), polybutylene sebacate adipate (PBSeA), polybutylene sebacate (PBSe), and also covers corresponding polyesteramides. The aliphatic polyesters are marketed by way of example by the following companies: Showa Highpolymers as Bionolle®, and by Mitsubishi as GSPIa®. More recent developments are described in WO 2010/034711.

The intrinsic viscosities of the aliphatic polyesters are generally from 150 to 320 cm³/g and preferably from 150 to 250 cm³/g, to DIN 53728.

MVR (melt volume rate) is generally from 0.1 to 70 cm³/10 min., preferably from 0.8 to 70 cm³/10 min., and in particular from 1 to 60 cm³/10 min., to EN ISO 1133 (190° C., 2.16 kg weight).

Acid numbers are generally from 0.01 to 1.2 mg KOH/g, preferably from 0.01 to 1.0 mg KOH/g, and particularly preferably from 0.01 to 0.7 mg KOH/g, to DIN EN 12634.

Semiaromatic polyesters, where these are likewise suitable as component i), are composed of aliphatic diols and of aliphatic, and also aromatic, dicarboxylic acids. Among the suitable semiaromatic polyesters are linear non-chain-extended polyesters (WO 92/09654). Particularly suitable partners in a mixture are aliphatic/aromatic polyesters derived from butanediol, from terephthalic acid, and from aliphatic C₄-C₁₈-dicarboxylic acids, such as succinic acid, glutaric acid, adipic acid, suberic acid, azelaic acid, sebacic acid, and brassylic acid (for example as described in WO 2006/097353 to 56). It is preferable to use chain-extended and/or branched semiaromatic polyesters as component i. The latter are known from the following specifications mentioned in the introduction: WO 96/15173 to 15176, 21689 to 21692, 25446, 25448 or from WO 98/12242, expressly incorporated herein by way of reference. It is also possible to use a mixture of various semiaromatic polyesters.

Particularly suitable materials are biodegradable, aliphatic-aromatic polyesters i which comprise:
a) from 40 to 70 mol %, based on components a to b, of one or more dicarboxylic acid derivatives or dicarboxylic acids selected from the group consisting of: succinic acid, adipic acid, sebacic acid, azelaic acid, and brassylic acid;
b) from 60 to 30 mol %, based on components a to b, of a terephthalic acid derivative;

c) from 98 to 102 mol %, based on components a to b, of a C₂-C₈-alkylenediol or C₂-C₆-oxyalkylenediol;
d) from 0.00 to 2% by weight, based on the total weight of components a to d, of a chain extender and/or crosslinking agent selected from the group consisting of: a di- or polyfunctional isocyanate, isocyanurate, oxazoline, epoxide, peroxide, and carboxylic anhydride, and/or an at least trihydric alcohol, or an at least tribasic carboxylic acid.

Aliphatic-aromatic polyesters i used with preference comprise:
a) from 50 to 65, based on components a to b, of one or more dicarboxylic acid derivatives or dicarboxylic acids selected from the group consisting of: succinic acid, azelaic acid, brassylic acid, and preferably adipic acid, particularly preferably sebacic acid;
b) from 50 to 35, based on components a to b, of a terephthalic acid derivative;
c) from 98 to 102 mol%, based on components a to b, of 1,4-butanediol, and
d) from 0 to 2% by weight, preferably from 0.01 to 2% by weight, based on the total weight of components a to d, of a chain extender and/or crosslinking agent selected from the group consisting of: a polyfunctional isocyanate, isocyanurate, oxazoline, carboxylic anhydride, such as maleic anhydride, or epoxide (in particular an epoxidized poly(meth)acrylate), and/or an at least trihydric alcohol, or an at least tribasic carboxylic acid.

Aliphatic dicarboxylic acids that are preferably suitable are succinic acid, adipic acid, and with particular preference sebacic acid. An advantage of said diacids is that they are also available in the form of renewable raw materials.

The polyesters i described are synthesized by the processes described in WO-A 92/09654, WO-A 96/15173, or preferably in WO-A 09/127555, and WO-A 09/127556, preferably in a two-stage reaction cascade. The dicarboxylic acid derivatives are first reacted with a diol in the presence of a transesterification catalyst, to give a prepolyester. The intrinsic viscosity (IV) of said prepolyester is generally from 50 to 100 ml/g, preferably from 60 to 80 ml/g. The catalysts used usually comprise zinc catalysts, aluminum catalysts, and in particular titanium catalysts.

An advantage of titanium catalysts, such as tetra(isopropyl) orthotitanate and in particular tetrabutyl orthotitanate (TBOT) over the tin catalysts, antimony catalysts, cobalt catalysts, and lead catalysts frequently used in the literature, an example being tin dioctoate, is that when residual amounts of the catalyst or a product formed from the catalyst are retained in the product they are less toxic. This is particularly important in the case of biodegradable polyesters, since they can pass directly into the environment by way of the composting process.

The polyesters i are then produced in a second step by the processes described in WO-A 96/15173 and EP-A 488 617. The prepolyester is reacted with chain extenders d, for example with diisocyanates or with epoxide-containing polymethacrylates, in a chain-extending reaction that gives a polyester with IV of from 150 to 320 ml/g, preferably from 180 to 250 ml/g.

The process generally uses from 0.01 to 2% by weight, preferably from 0.1 to 1.0% by weight, and with particular preference from 0.1 to 0.3% by weight, based on the total weight of components i to iii, of a crosslinking agent (d′) and/or chain extender (d) selected from the group consisting of: a polyfunctional isocyanate, isocyanurate, oxazoline, epoxide, peroxide, carboxylic anhydride, an at least trihydric alcohol, or an at least tribasic carboxylic acid. Chain extenders d that can be used are polyfunctional, and in particular difunctional, isocyanates, isocyanurates, oxazolines, carboxylic anhydride, or epoxides.

Chain extenders, and also alcohols or carboxylic acid derivatives having at least three functional groups, can also be interpreted as crosslinking agents d′. Particularly preferred compounds have from three to six functional groups. Examples that may be mentioned are: tartaric acid, citric acid, malic acid; trimethylolpropane, trimethylolethane; pentaerythritol; polyethertriols and glycerol, trimesic acid, trimellitic acid, trimellitic anhydride, pyromellitic acid, and pyromellitic dianhydride. Preference is given to polyols, such as trimethylolpropane, pentaerythritol, and in particular glycerol. By using components d and d′ it is possible to construct biodegradable polyesters which are pseudoplastic. The rheological behavior of the melts improves; the biodegradable polyesters are easier to process. The compounds d act to reduce viscosity under shear, i.e. viscosity at relatively high shear rates is reduced.

The number-average molar mass (Mn) of the polyesters i is generally in the range from 10 000 to 100 000 g/mol, in particular in the range from 15 000 to 75 000 g/mol, preferably in the range from 20 000 to 38 000 g/mol, while their weight-average molar mass (Mw) is generally from 30 000 to 300 000 g/mol, preferably from 60 000 to 200 000 g/mol, and their Mw/Mn ratio is from 1 to 6, preferably from 2 to 4. Intrinsic viscosity is from 150 to 320 g/ml, preferably from 180 to 250 g/ml (measured in o-dichlorobenzene/phenol (ratio by weight 50/50). The melting point is in the range from 85 to 150° C., preferably in the range from 95 to 140° C.

The polyesters mentioned can have hydroxy and/or carboxy end groups in any desired ratio. The semiaromatic polyesters mentioned can also be end-group-modified. By way of example, therefore, OH end groups can be acid-modified via reaction with phthalic acid, phthalic anhydride, trimellitic acid, trimellitic anhydride, pyromellitic acid, or pyromellitic anhydride. Preference is given to polyesters having acid numbers smaller than 1.5 mg KOH/g.

The biodegradable polyesters i can comprise further ingredients which are known to the person skilled in the art but which are not essential to the invention. By way of example, the additional materials conventional in plastics technology, such as stabilizers; nucleating agents; lubricants and release agents, such as stearates (in particular calcium stearate); plasticizers, such as citric esters (in particular tributyl acetylcitrate), glycerol esters, such as triacetylglycerol, or ethylene glycol derivatives, surfactants, such as polysorbates, palmitates, or laurates; waxes, such as beeswax or beeswax ester; antistatic agent, UV absorber, UV stabilizer; antifogging agents, or dyes. The concentrations used of the additives are from 0 to 5% by weight, in particular from 0.1 to 2% by weight, based on the polyesters of the invention.

It is preferable to use, as component ii), polylactic acid with the following property profile:
melt volume rate (MVR at 190° C. and 2.16 kg to ISO 1133 of from 0.5 to 15 ml/10 minutes, preferably from 1 to 9 ml/10 minutes, particularly preferably from 2 to 8 ml/10 minutes),
melting point below 180° C.
glass transition temperature (Tg) above 40° C.
water content smaller than 1000 ppm
residual monomer content (lactide) smaller than 0.3%
molecular weight greater than 50 000 daltons.

Examples of preferred polylactic acids are the following from NatureWorks®: Ingeo® 2002 D, 4032 D, 4042 D and 4043 D, 8251 D, 3251 D, and in particular 8051 D and 8052 D. NatureWorks Ingeo® 8051 D and 8052 D are polylactic acids from NatureWorks with the following product properties: Tg: 65.3° C., Tm: 153.9° C., MVR: 6.9 [ml/10 minutes], M_{w}:186 000, Mn:107 000. These products moreover have a slightly higher acid number.

Polylactic acids with MVR to ISO 1133 [190° C./2.16 kg] of from 5 to 8 ml/10 minutes have proven particularly advantageous for producing the expandable pelletized materials of the invention.

Component iii) is described in more detail below.

The definition of epoxides in particular covers a copolymer which contains epoxy groups and which is based on styrene, acrylate and/or methacrylate. The units bearing epoxy groups are preferably glycidyl (meth)acrylates. Copolymers which have proven advantageous have a proportion of glycidyl methacrylate greater than 20% by weight of the copolymer, particularly preferably greater than 30% by weight of the copolymer, and with particular preference greater than 50% by weight of the copolymer. The epoxy equivalent weight (EEW) in these polymers is preferably from 150 to 3000 g/equivalent, and with particular preference from 200 to 500 g/equivalent. The average (weight-average) molecular weight M_{w} of the polymers is preferably from 2000 to 25 000, in particular from 3000 to 8000. The average (number-average) molecular weight Mₙ of the polymers is preferably from 400 to 6000, in particular from 1000 to 4000. Polydispersity (Q) is generally from 1.5 to 5. Copolymers of the abovementioned type containing epoxy groups are marketed by way of example with trademark Joncryl® ADR by BASF Resins B.V. Joncryl® ADR 4368 is particularly suitable as chain extender.

The definition of component iv in particular covers one or more of the following additional materials: stabilizer, nucleating agent, lubricant and release agent, surfactant, wax, antistatic agent, antifogging agent, dye, pigment, UV absorber, UV stabilizer, or other plastics additive. The amount preferably used of component iv is from 0.5 to 1% by weight, based on components i and iv.

The molding compositions of the invention comprise from 69 to 98% by weight, preferably from 75 to 92% by weight, and with particular preference from 80 to 90% by weight, of the thermoplastic A, and accordingly from 2 to 31% by weight, preferably from 8 to 25% by weight, and with particular preference from 10 to 20% by weight, of the polymer mixture B. Notched impact resistance generally rises with increasing proportion of the polymer mixture B.

Amounts used of the additional materials C are from 0 to 40% by weight, in particular from 0.5 to 30% by weight, based on components A to C. The high proportions by weight can be used in particular for fillers.

Preferred fibrous fillers C that may be mentioned are carbon fibers, aramid fibers, glass fibers, and potassium titanate fibers, and particular preference is given here to glass fibers in the form of E glass. These are used as rovings in the forms commercially available.

The diameter of the glass fibers used as rovings in the invention are from 6 to 20 μm, preferably from 10 to 18 μm, and the cross section of these glass fibers is round, oval, or polyhedral. In particular, the invention uses E glass fibers. However, it is also possible to use any of the other types of glass fiber, for example fibers of A, C, D, M, S, or R glass, or any desired mixture thereof, or a mixture with E glass fibers.

The fibrous fillers can have been surface-pretreated with a silane compound in order to improve compatibility with the thermoplastics.

Suitable silane compounds are those of the general formula

(X—(CH₂)ₙ)ₖ—Si—(O—CₘH₂ₘ₊₁)₄₋ₖ

where the definitions of the substituents are as follows:

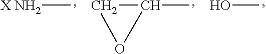

n is an integer from 2 to 10, preferably from 3 to 4

m is an integer from 1 to 5, preferably from 1 to 2

k is an integer from 1 to 3, preferably 1.

Preferred silane compounds are aminopropyltrimethoxysilane, aminobutyltrimethoxysilane, aminopropyltriethoxysilane, aminobutyltriethoxysilane, and also the corresponding silanes which comprise a glycidyl group as substituent X.

The amounts generally used of the silane compounds for surface coating are from 0.01 to 2% by weight, preferably from 0.025 to 1.0% by weight, and in particular from 0.05 to 0.5% by weight (based on C)).

Other suitable coating compositions (also termed size) are based on isocyanates.

The L/D (length/diameter) ratio is preferably from 100 to 4000, in particular from 350 to 2000, and very particularly from 350 to 700.

The thermoplastic molding compositions also advantageously comprise a lubricant C. The molding compositions of the invention can comprise, as component C, from 0 to 3% by weight, preferably from 0.05 to 3% by weight, with preference from 0.1 to 1.5% by weight, and in particular from 0.1 to 1% by weight, of a lubricant, based on the total amount of components A to C.

Preference is given to the aluminum, alkali metal, or alkaline earth metal salts, or esters or amides of fatty acids having from 10 to 44 carbon atoms, preferably having from 14 to 44 carbon atoms. The metal ions are preferably alkaline earth metal and Al, particular preference being given to Ca or Mg. Preferred metal salts are Ca stearate and Ca montanate, and also Al stearate. It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The thermoplastic molding compositions of the invention can comprise, as further component C, conventional processing aids, such as stabilizers, oxidation retarders, further agents to counter decomposition by heat and decomposition by ultraviolet light, lubricants and mold-release agents, colorants, such as dyes and pigments, nucleating agents, plasticizers, flame retardants, etc.

Examples that may be mentioned of oxidation retarders and heat stabilizers are phosphites and other amines (e.g. TAD), hydroquinones, various substituted representatives of these groups, and mixtures of these, in concentrations of up to 1% by weight, based on the weight of the thermoplastic molding compositions.

UV stabilizers that may be mentioned, where the amounts used of these are generally up to 2% by weight, based on the molding composition, are various substituted resorcinols, salicylates, benzotriazoles, and benzophenones.

Colorants that can be added are inorganic pigments, such as titanium dioxide, ultramarine blue, iron oxide, and carbon black, and/or graphite, and also organic pigments, such as phthalocyanines, quinacridones, perylenes, and also dyes, such as nigrosin, and anthraquinones.

Nucleating agents that can be used are sodium phenylphosphinate, aluminum oxide, silicon dioxide, and also preferably talc.

Flame retardants that may be mentioned are red phosphorus, P- and N-containing flame retardants, and also halogenated flame-retardant systems, and synergists of these.

### EXAMPLES

### Test Methods and Properties

Intrinsic viscosity was determined to DIN 53728 Part 3, Jan. 3, 1985. Solvent used was a phenol/dichlorobenzene mixture in a ratio by weight of 50/50.

Charpy notched impact resistance was determined to ISO 179-2/1eA at respectively 23° C. and −30° C.

Yield stress, modulus of elasticity, and tensile strain at break were determined to ISO 527-2:1993. The tensile testing speed was 5 mm/min.

Starting Materials

The following components were used:

Component A:

Ai: PVC 250 SB from Solvin SA (CAS:9002-86-2, density: 590 g/l, residual monomer content:<1 ppm, melting point: 75-85° C.)

Aii: Ultramid® B27E from BASF SE (CAS:25038-54-4, density: 1120-1150 g/l, melting point: 220° C., relative viscosity (1% in 96% H2SO4): 2.7±0.03)

Component B:

Bi: 67.9% by weight of Ecoflex® C1200 (previous product name: Ecoflex® FBX 7011)—a polybutylene adipate-co-terephthalate from BASF SE, 32% by weight of Ingeo® 4043D polylactic acid (PLA) from Natureworks LLC; 0.1% by weight of Joncryl® ADR 4368—a copolymer containing epoxy groups and based on styrene, acrylate, and/or methacrylate from BASF Resins B.V.

Bii: 54.9% by weight of Ecoflex® C1200 (previous product name: Ecoflex® FBX 7011)—a polybutylene adipate-co-terephthalate from BASF SE, 45% by weight of Ingeo® 4043D polylactic acid (PLA) from Natureworks LLC; 0.1% by weight of Joncryl® ADR 4368—a copolymer containing epoxy groups and based on styrene, acrylate, and/or methacrylate from BASF Resins B.V.

Component C:

Ci: Baerostab M25-85 from Baerlocher GmbH (Baerostab M25-85 is a modified butyltin mercaptide. This product comprises a non-migrating lubricant, and was developed as PVC stabilizer. Density at 20° C.: 1080 g/l, viscosity at 20° C.: 80 mPa·s)

Cii: Acrawax C from Lonza AG (composed of N,N′-ethylenebisstearamide (CAS:110-30-5), N,N′-ethane-1,2-diylbishexadecan-1-amide (CAS: 5518-18-3), C14.18-fatty acids (CAS: 67701-02-4), melting point: 140-145° C.)

Ciii: Irganox 98 from BASF SE (N,N′-hexane-1,6-diylbis[3-(3,5-di-tert-butyl-4-hydroxyphenylpropionamide)], CAS number: 23128-74-7, melting point: 156-165° C.)

Civ: IT talc powder from Mondo Minerals (CAS: 14807-96-6, density:2750 g/I)

### Example 1

The molding compositions of comparative example 1 and of inventive example 1 were produced at 180° C. using a rotation rate of 80 1/min in a DSM miniextruder:

### Production of Test Specimens

The test specimens used to determine properties were produced by using a DSM injection-molding machine. The melt mixture produced in the DSM miniextruder was forced at 180° C. by a pressure of 15 bar into the mold, the temperature of which was 70° C. The notch was milled into the Charpy specimen to ISO 179-2/1eA(F), and the test was carried out.

TABLE 1
Effect of component B on the notched impact resistance of PVC

| Components | Comparative | Inventive |
|---|---|---|
| [% by wt.] | example 1V | example 1 |
| Ai) | 98 | 88 |
| Bi) | | 10 |
| Ci) | 2 | 2 |
| Total | 100 | 100 |
| Charpy notched | 1.4 | 2.0 |
| [kJ/m²] at 23° C. | | |

The constitutions of the molding compositions and the results of the tests can be found in table 1. The notched impact resistance of inventive example 1, using polymer mixture B of the invention, was 42% higher than that of comparative example 1.

### Example 2

The molding compositions of comparative example 2 and of inventive examples 2 and 3 were produced at 260° C. using a rotation rate of 250 1/min in a ZSK 30:

### Production of Test Specimens

The test specimens used to determine properties were produced by using a Battenfeld 50 injection-molding machine. The pelletized materials produced in 2) and 3) were melted and injected into the mold, using a rotation rate of 100 rpm for the screw and a residence time of 50 s. The test specimens for the tensile tests were produced to ISO 527-2/1N50, and the test specimens for the impact resistance tests were produced to ISO 179-2/1eA(F). Injection temperature was 260° C. and mold temperature was 80° C.

TABLE 2
Effect of component B on notched impact resistance of polyamide

| Components | Comparative | Inventive | Inventive |
|---|---|---|---|
| [% by wt.] | example 2V | example 2 | example 3 |
| Aii) | 98.61 | 88.75 | 69.03 |
| Bii) | | 10 | 30 |
| Cii) | 1.11 | 1 | 0.78 |
| Ciii) | 0.22 | 0.2 | 0.16 |
| Civ) | 0.06 | 0.05 | 0.04 |
| Total | 100 | 100 | 100 |
| Charpy notched | 4.4 | 6.4 | 10.6 |
| [kJ/m²] at 23° C. | | | |
| Charpy notched | 2.7 | 3.2 | 5.0 |
| [kJ/m²] at −30° C. | | | |

The constitutions of the molding compositions and the results of the tests can be found in table 2. The notched impact resistance exhibited by inventive example 2 using 10% by weight of polymer mixture B at 23° C. (−30° C.) of the invention was 45% (19%) higher than that of comparative example 2. The notched impact resistance exhibited by inventive example 3 using 30% by weight of polymer mixture B at 23° C. (−30° C.) of the invention was 141% (85%) higher than that of comparative example 2.

The tensile properties: tensile strength at break, tensile strength, and modulus of elasticity were better in inventive example 3 than in inventive example 2, and were at a level similar to that of comparative example 2V.

1.-6. (canceled)

7. A thermoplastic molding composition comprising
A) from 69 to 98% by weight, based on components A and B, of a thermoplastic selected from the group consisting of polyvinyl chloride, polystyrene, polymethyl methacrylate, polyamide, polybutylene terephthalate, and polyoxymethylene;
B) from 2 to 31% by weight, based on components A and B, of a polymer mixture comprising:
i) from 30 to 70% by weight, based on the total weight of components i to ii, of at least one polyester based on aliphatic and/or aromatic dicarboxylic acids and on an aliphatic dihydroxy compound;
ii) from 70 to 30% by weight, based on the total weight of components i to ii, of polylactic acid;
iii) from 0 to 10% by weight, based on the total weight of components i to iv, of a copolymer which contains epoxy groups and which is based on styrene, acrylate, and/or methacrylate;
iv) from 0 to 15% by weight, based on the total weight of components i to iv, of nucleating agents, lubricants and antiblocking agents, waxes, antistatic agents, and defogging agents, or dyes; and
C) from 0 to 40% by weight, based on components A to C, of other additional materials.

8. The thermoplastic molding composition of claim 7, wherein the thermoplastic A is an amorphous polymer selected from the group consisting of: polyvinyl chloride, polystyrene, and polymethyl methacrylate.

9. The thermoplastic molding composition of claim 7, wherein the thermoplastic A is a semicrystalline polymer selected from the group consisting of: polyamide, polybutylene terephthalate, and polyoxymethylene.

10. A process for increasing the notched impact resistance of a thermoplastic A, said process comprising mixing
A) from 69 to 98% by weight, based on components A and B, of a thermoplastic A selected from the group consisting of polyvinyl chloride, polystyrene, polymethyl methacrylate, polyamide, polybutylene terephthalate, and polyoxymethylene, and
B) from 2 to 31% by weight, based on components A and B, of a polymer mixture B comprising:
i) from 30 to 70% by weight, based on the total weight of components i to ii, of at least one polyester based on aliphatic and/or aromatic dicarboxylic acids and on an aliphatic dihydroxy compound;
ii) from 70 to 30% by weight, based on the total weight of components i to ii, of polylactic acid;
iv) from 0 to 10% by weight, based on the total weight of components i to iv, of a copolymer which contains epoxy groups and which is based on styrene, acrylate, and/or methacrylate;
iv) from 0 to 15% by weight, based on the total weight of components i to iv, of nucleating agents, lubricants and antiblocking agents, waxes, antistatic agents, and defogging agents, or dyes; and
C) from 0 to 40% by weight, based on components A to C, of other additional materials.

11. The process of claim 10, wherein the thermoplastic A is an amorphous polymer selected from the group consisting of polyvinyl chloride, polystyrene, and polymethyl methacrylate.

12. The process of claim 10, wherein the thermoplastic A is a semicrystalline polymer selected from the group consisting of polyamide, polybutylene terephthalate, and polyoxymethylene.
